(19) United States
(12) Patent Application Publication
(10) Pub. No.: US 2010/0007058 A1
(43) Pub. Date: Jan. 14, 2010

(54) Injection Molding Apparatus Having Aligned Pin and Sleeve and Method of Operation

(75) Inventor: Fabrice Fairy, Barbizon (FR)

Correspondence Address: MOLD-MASTERS (2007) Limited, 233 ARMSTRONG AVENUE, INTELLECTUAL PROPERTY DEPARTMENT, GEORGETOWN, ON, L7G-4X5, CA

(73) Assignee: MOLD-MASTERS (2007) LIMITED, Georgetown (CA)

(21) Appl. No.: 12/500,800

(22) Filed: Jul. 10, 2009

Related U.S. Application Data
(60) Provisional application No. 61/079,944, filed on Jul. 11, 2008.

(51) Int. Cl. B29C 45/40; B29C 45/72

(52) U.S. Cl. 264/328.16; 425/577; 425/547; 264/334

(57) ABSTRACT

In an injection molding apparatus having a manifold and nozzle assembly, a pin extends through the nozzle and into a mold cavity to define a product feature of the mold cavity and a sleeve extends through the nozzle and circumferentially surrounds a portion of the pin. The sleeve can be moved for controlling flow of molding material through a mold gate and into the mold cavity. The sleeve is aligned with the mold gate by an alignment portion of the nozzle when actuated to open the mold gate. The pin is aligned in the mold cavity by the sleeve.

### CROSS-REFERENCE TO RELATED APPLICATIONS

This application claims the benefit of U.S. provisional patent application No. 61/079,944 filed Jul. 11, 2008, which is hereby incorporated by reference in its entirety herein.

### FIELD OF THE INVENTION

The present invention relates to injection molding, and more particularly, to an injection molding apparatus that receives molding material from an injection molding machine and conveys it to a mold cavity or cavities and method of operating the same.

### BACKGROUND OF THE INVENTION

For many injection molded products, such as flip-top closures, one challenge is to locate the mold gate of an injection molding apparatus that will be used to injection mold the product. Complicated product design can increase this challenge. For example, when a closure has a through-hole through which a liquid, such as shampoo, is conveyed, the mold gate is difficult to locate without resulting in a product having poor quality, strength problems, and/or unattractive flow lines.

### BRIEF SUMMARY OF THE INVENTION

According to one aspect of the invention, a pin extends through the nozzle to define a product feature of a mold cavity and a sleeve extends through the nozzle and circumferentially surrounds a portion of the pin. The sleeve can be moved for controlling flow of molding material through a mold gate and into the mold cavity. The sleeve is aligned with the mold gate by an alignment portion of the nozzle when actuated to open the mold gate. The pin is aligned in the mold cavity by the sleeve.

### BRIEF DESCRIPTION OF THE FIGURES

Embodiments of the present invention will now be described more fully with reference to the accompanying drawings.

FIG. 1 is a cross-sectional view of an injection molding apparatus according to an embodiment of the present invention.

FIG. 2 is a cross-sectional view of the injection molding apparatus of FIG. 1 at the downstream end of the nozzle when the mold gate is closed.

FIG. 3 is a cross-sectional view of the injection molding apparatus of FIG. 1 at the downstream end of the nozzle when the mold gate is open.

FIG. 4 is a cross-sectional view of the injection molding apparatus of FIG. 1 around the actuator.

FIG. 5 is a perspective view of a flip-top closure made according to an embodiment of the present invention.

FIG. 6 is a cross-sectional view at the downstream end of a nozzle of another embodiment of the present invention.

### DETAILED DESCRIPTION OF THE INVENTION

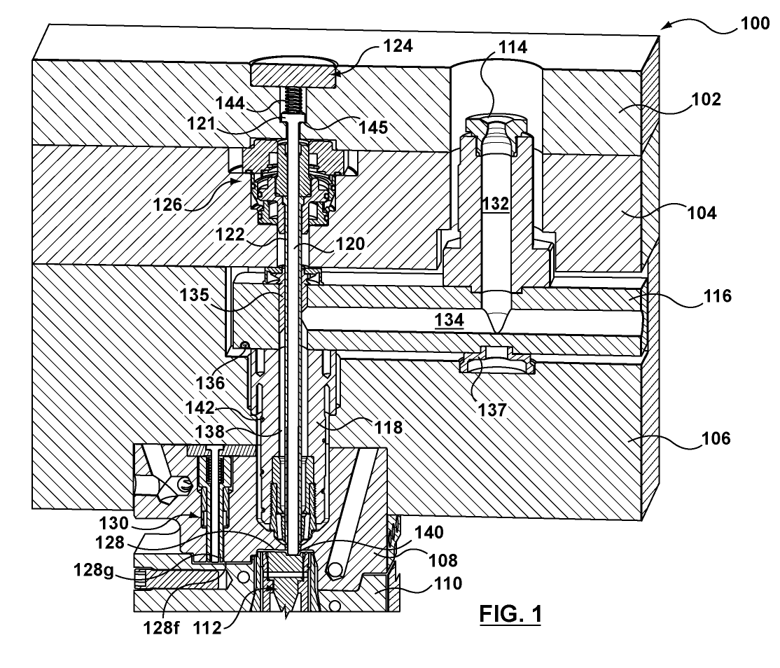

FIG. 1 shows a cross-sectional view of an injection molding apparatus 100 according to an embodiment of the present invention. The injection molding apparatus 100 comprises a backing plate 102, an actuator plate 104, a manifold plate 106, cavity plate 108, core plate 110, a mold core or core assembly 112, an inlet component 114, a manifold 116, one or more nozzles 118 (only one shown), a pin 120 (not hatched), a sleeve 122, a pin holder 124, and a sleeve actuator 126. The injection molding apparatus 100 may include one or more than one nozzles 118, one being shown for clarity. Additional nozzles are not shown in this sectional view, the illustrated nozzle being representative. The features and aspects described for the other embodiments can be used accordingly with the present embodiment.

The backing plate 102, actuator plate 104, manifold plate 106, cavity plate 108, and core plate 110 are stacked together. The backing plate 102, actuator plate 104, and manifold plate 106 define a plate assembly in which the manifold 116, nozzle 118, actuator 126, and pin holder 124 are fixed. More or fewer plates may be used to define the plate assembly, this being a design choice. A mold cavity 128 is defined between the cavity plate 108, core plate 110 and the mold core 112, which can be separated to eject a molded product formed within the mold cavity 128. The molded product may be, for example, a flip-top closure such as the kind used on the tops of shampoo bottles. The cavity plate 108, core plate 110 and/or the mold core 112 may be cooled. A feature assembly 130 may be provided in the cavity plate 108 to define a feature of the molded product, in this case a boss for a flip-top cap closure. Other configurations of cavity plates and/or cores may be used as well.

The inlet component 114 is connected to the manifold 116 and defines an inlet channel 132 that feeds the manifold 116 with a molding material, such as molten plastic resin. The inlet component 114 can be connected to an injection molding machine, not shown, which supplies the molding material.

The manifold 116 defines a manifold channel 134, or network of channels, for distributing the molding material received from the communicating inlet channel 132. The manifold 116 may include a manifold heater 136 such as an insulated resistance wire heater. The manifold 116 may also be provided with a bushing 135 to guide and seal sliding of the sleeve 122. A locating ring 137 may further be provided to locate and/or support the manifold 116 in the plate assembly.

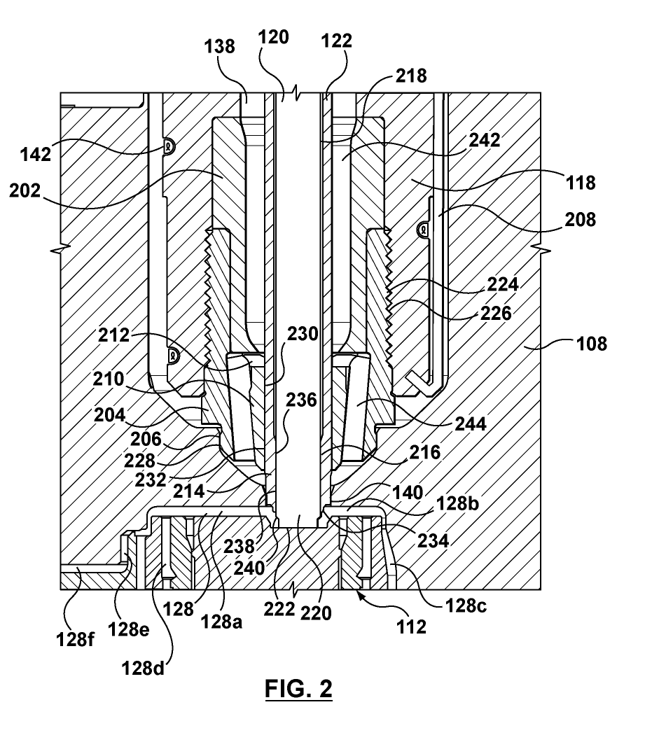

The nozzle 118 is connected to the manifold 116 and defines a nozzle channel 138 that is in communication with the manifold channel 134. The nozzle channel 138 is for conveying molding material to a ring-type mold gate 140 of the mold cavity 128. An alignment portion is defined by a nozzle tip, which is removably retained to the body of the nozzle 118 by a tip retainer. The alignment portion, nozzle tip, and tip retainer will be described in further detail in FIG. 2 below. The nozzle 118 may further include a nozzle heater 142, such as an insulated resistance wire heater, and thermocouple. As mentioned above, one or more nozzles 118 may be provided.

The manifold 116, nozzle(s) 118, and inlet component 114 can be considered to form a manifold and nozzle assembly defining one or more heated channels 132, 134, 138 for conveying molding material from an injection molding machine to one or more mold cavities 128. The inlet component 114 may be omitted from this definition. When one or more heaters are used, such an assembly can be termed a hot runner. As will be discussed in detail below, the manifold and nozzle assembly has an alignment portion adjacent the mold cavity 128 to continuously align the sleeve 122 to the mold gate 140.

The pin 120 extends through the nozzle 118 and is used to define a product feature, such as a through-hole, of the mold cavity 128. In this embodiment, the actuator components are provided with bores to allow the pin 120 to extend through the actuator 126 to pin holder 124. The pin 120 may be provided as coaxial with the sleeve 122, as shown. The pin 120 is aligned in the mold cavity 128, which is aligned with respect to the mold gate 140, by maintaining a sliding contact between a portion of the pin 120 and the sleeve 122, as explained in detail with respect to FIG. 2. Although the pin 120 may be allowed to move a little (e.g., by a spring bias described below), the pin 120 can be considered as fixed or stationary with respect to the nozzle 118 when the mold is closed. In the case of a closure product, the pin 120 penetrates all the way through the mold cavity 128 and contacts the mold core 112 to define a through-hole in the finished closure.

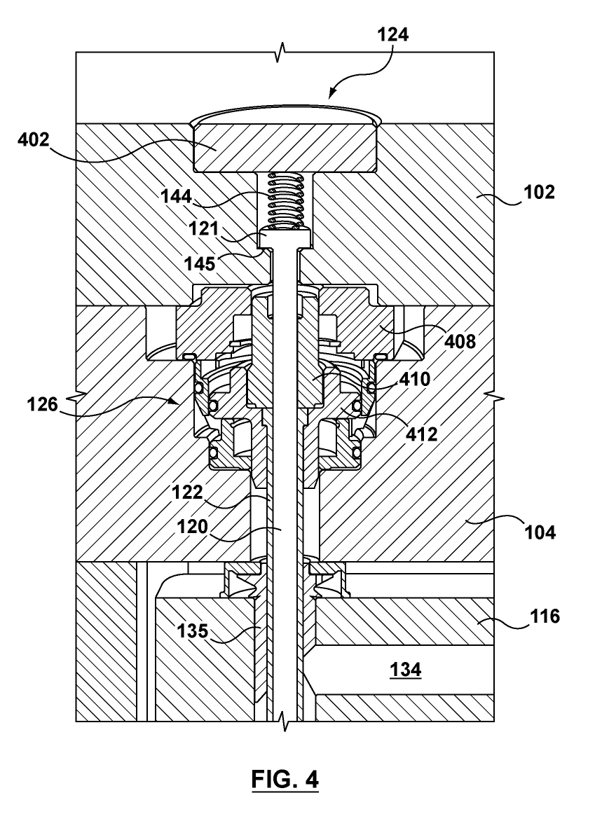

The pin holder 124 is connected to the backing plate 102 or generally to the plate assembly. The pin holder 124 may include a spring 144 held in contact with a head 121 of the pin 120 by a spring cover cap 402 (see FIG. 4) fixed to the backing plate 102. The head 121 of the pin 120 is pushed by the spring 144 against a shoulder 145 of the backing plate 102. In this way, the pin 120 is held by the pin holder 124. The biasing effect of the spring 144 seats the pin 120 in the mold cavity 128. When the mold is closed, that is, when the cavity plates 108, core plate 110 and/or mold core 112 are brought together to form the mold cavity 128, the pin 120 abuts the mold core 112. The spring 144 can dampen the shock or force against pin 120 when closing the mold and also can ensure that the pin 120 remains in contact with the mold core 112 to properly define the through-hole.

The hollow sleeve 122 extends through the nozzle 118 and circumferentially surrounds a portion of the pin 120, which in this embodiment is the majority of the pin 120. The sleeve 122 is movable (up and down in the figure) for controlling flow of molding material through the mold gate 140 and into the mold cavity 128. The sleeve 122 is aligned with the mold gate 140 by the alignment portion of the nozzle 118, as will be discussed. In this embodiment, the sleeve is cylindrical, but other cross-sections are also useable.

The actuator 126 is connected to the sleeve 122 and serves to move the sleeve 122 between opened and closed positions of the mold gate 140. The actuator 126 is situated mainly in a recess in the actuator plate 104. The actuator 126 may generally be situated anywhere in the plate assembly. The actuator 126 may be a pneumatic, hydraulic, electric, or another kind of actuator. If sleeves are to be ganged to operate in unison, a plate-type actuator can be used, in which one or more actuators actuate a common plate to which the sleeves are connected.

FIG. 2 shows a close-up of the injection molding apparatus 100 of FIG. 1 at the downstream end of the nozzle 118. The components are shown positioned such that the pin 120 is in contact with the mold core 112 to define the through-hole in the product and the sleeve 122 closes the mold gate 140.

As can be seen, a nozzle tip 202 is received in a bore in the downstream end of the nozzle 118 and held in place by a tip retainer 204 with an inner surface 224 that threads into the nozzle 118. The tip retainer 204 has a seal portion 206 with an outer surface 228 that seals with against an inner surface of the cavity plate 108 to prevent leakage of molding material. A thermocouple 208 is provided at the downstream end of the nozzle 118 to measure the temperature of the molding material.

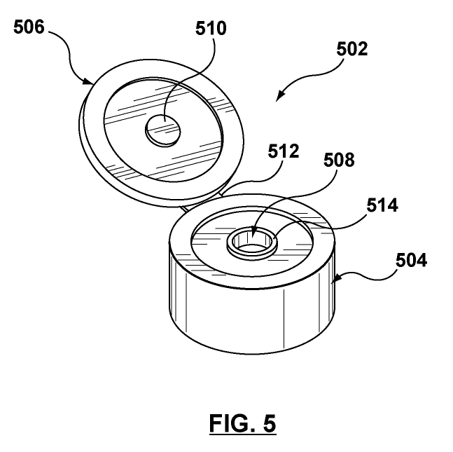

An alignment portion 210 is located at the downstream end of the nozzle tip 202. In this embodiment, the alignment portion 210 is a hollow cylinder with a bore with which the sleeve 122 slidably mates. In this embodiment, alignment portion 210 is unitary with the nozzle tip 202. In particular, alignment portion 210 includes an inner surface 20 that contact an outer surface 232 of sleeve 122 to guide or align sleeve 122 with mold gate 140. Other structures that guide and/or align the sleeve 122 with the mold gate 140 are also possible. To accommodate flow of molding material around the alignment portion 210, the nozzle tip 202 further includes at least one lateral channel 212 upstream of the alignment portion 210. The lateral channel 212 may be perpendicular to or at another angle to the central nozzle tip melt channel 242. The lateral channel 212 leads to an annular melt channel 244 surrounding the alignment portion 210 and downstream of the lateral channel 212. The lateral channel 212 allows for tight mating of the sleeve 122 and the alignment portion 210, so that the alignment portion 210 can guide the sleeve 122 to align to the mold gate 140. Accordingly, the tip 214 of the sleeve 122 can be brought into accurate engagement with the mold gate 140. As shown in FIG. 2, the tip 214 of the sleeve 122 closes the cavity 128 because the tip 214 is advanced into mold gate 140, thereby preventing flow through mold gate 140 into mold cavity 128. Further, in the embodiment shown, tip 214 includes a lip 234 that defines another product feature of the mold cavity 128, in this case, a rounded edge (fillet) (like element 514 of FIG. 5) of the through-hole.

The pin 120 is aligned to the mold gate 140 by contacting a portion of the sleeve 122 at a contact region 216. In particular, an inner surface 236 of sleeve 122 contacts an outer surface 238 of pin 120 at contact region 216. The contact region 216 is downstream of a non-contact region 218 where the pin 120 and the sleeve 122 are not required to touch. The nature of contact of the pin 120 and the sleeve 122 at the contact region 216 is tight enough to resist molding material from getting between the pin 120 and the sleeve 122 but loose enough to allow relative motion between the pin 120 and the sleeve 122. Thus, the tip 220 of the pin 120 slidably mates with the tip 214 of the sleeve 122. The alignment portion 210 of the nozzle tip 202 generally circumferentially surrounds the portion of the sleeve 122 that contacts the pin 120 at the contact region 216, that is, surrounds the sleeve tip 214 and the pin tip 220. Accordingly, the tip 220 of the pin 120 extends through the cavity 128 and can be accurately brought into contact (as indicated at 222) with the mold core 112 (or cavity plate, in another embodiment) to define the product feature as a through-hole.

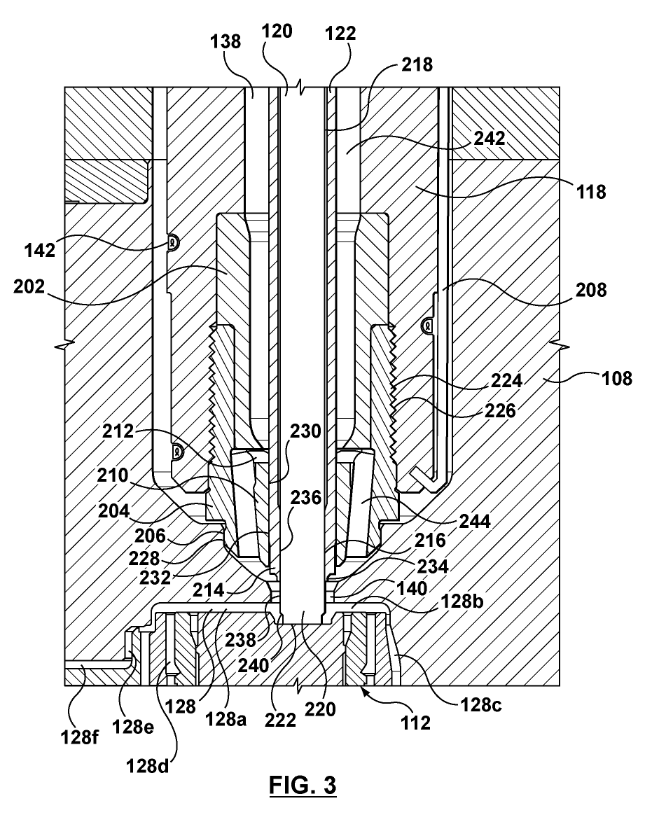

FIG. 3 shows another close-up of the injection molding apparatus 100 of FIG. 1 at the tip of the nozzle 118. In this view, the components are shown positioned such that the pin 120 is in contact with the mold core 112 to define the through-hole in the product and the sleeve 122 is disengaged from the mold gate 140 to open the mold gate 140.

As evident from the opened position shown in this FIG. 3 and the closed position shown in FIG. 2, the sleeve 122 is aligned with the mold gate 140 by the alignment portion 210 while the mold gate 140 is open and molding material flows through the gate 140. In this embodiment, the sleeve 122 slidably mates with the alignment portion 210 over the entire range of its motion. While sliding the sleeve 122 between opened and closed positions of the mold gate 140, the portion of the sleeve 122 adjacent the mold gate 140 is in contact with the alignment portion 210 and thus is continuously aligned to the mold gate 140. In both sleeve positions, the pin tip 220 is in contact with the mold core 112 (or cavity plate) to define the through-hole of the product, as shown at 222. The pin tip 220 is also in contact with the sleeve tip 214 to align the pin tip 220 with the mold gate 140, as shown at pin contact region 216. When the mold gate 140 is opened, heated molding material is injected into the nozzle channel 138 from manifold melt channel 134. The heated molding material flows through the nozzle tip central channel 242, the lateral channels 212, the annular channel 244 around the sleeve 122, and through the mold gate 140 in an annular flow that is concentric with the through-hole of the product, and into the mold cavity 128. Pin tip 220 further includes a shoulder 240 that defines the shape of the through-hole of the product. Continuous alignment of the pin 120 to the mold gate 140 by the sleeve 122 accurately locates the through-hole of the molded product. Continuous alignment of the sleeve 122 to the mold gate 140 by the alignment portion 210 of the nozzle 118 allows accurate closing of the mold gate 140.

FIG. 4 shows a close-up of the injection molding apparatus 100 of FIG. 1 around the actuator 126. The pin holder 124 includes the spring 144 held between a spring cover cap 402 and the head 121 of the pin 120, which is biased against shoulder 145 of the backing plate 102 by the spring 144 to dampen shock resulting from closing the mold and also ensure that the pin 120 remains in contact with the mold core 112 to properly define the product through-hole. Components of the actuator 126, such as a piston cap 408, a pin collar 410, and a piston 412, have bores to accommodate the pin 120 extending through the actuator 126.

A closure can be injection molded with the injection mold apparatus 100 described above using the following method. To define a through-hole of the closure, when closing the mold (i.e., by bringing together the cavity plate 108, core plate 110 and the mold core 112) to define the mold cavity 128, the pin 120 is aligned inside the mold cavity 128 by the portion of the sleeve 122 that circumferentially surrounds and contacts the pin 120 at the contact region 216 adjacent the mold cavity 128. As the mold is closed, the spring 144 biases the pin 120 against the mold core 112 to define the through-hole of the closure. After the mold is closed, the sleeve 122 is moved by the actuator 126 to open the mold gate 140 while the portion of the sleeve 122 adjacent the mold gate 140 is kept aligned to the mold gate by the alignment portion 210 (see FIG. 3). Then, molding material is injected and flows around the sleeve 122, through the mold gate 140 with a concentric annular flow, around the tip 220 of the pin 120 inside the mold cavity 128, and into the mold cavity 128. After the mold cavity 128 is filled with molding material, the sleeve 122 is moved by the actuator 126 to close the mold gate 140 (see FIG. 2). Then, the mold is opened and the closure is ejected. An example of such a flip-top closure 502 is depicted in FIG. 5, including a base 504, a lid 504 a through-hole 508 through base 504, a fillet 514 of through-hole 508, a boss 510 on lid 506 to mate with through-hole 508 to close through-hole 508, and a hinge 512 connecting lid 506 to base 504. Although the flip-top closure 502 depicted in FIG. 5 is only an example of a closure and it does not match exactly to the shape of cavity 128 shown in FIGS. 1-3, melt filling cavity portions 128a-128d shown in FIGS. 1-3 generally form a base with the through-hole being formed by the pin tip, cavity portion 128e generally forms the hinge, and cavity portion 128f generally forms the lid, with cavity portion 128g (FIG. 1) forming the boss on the lid.

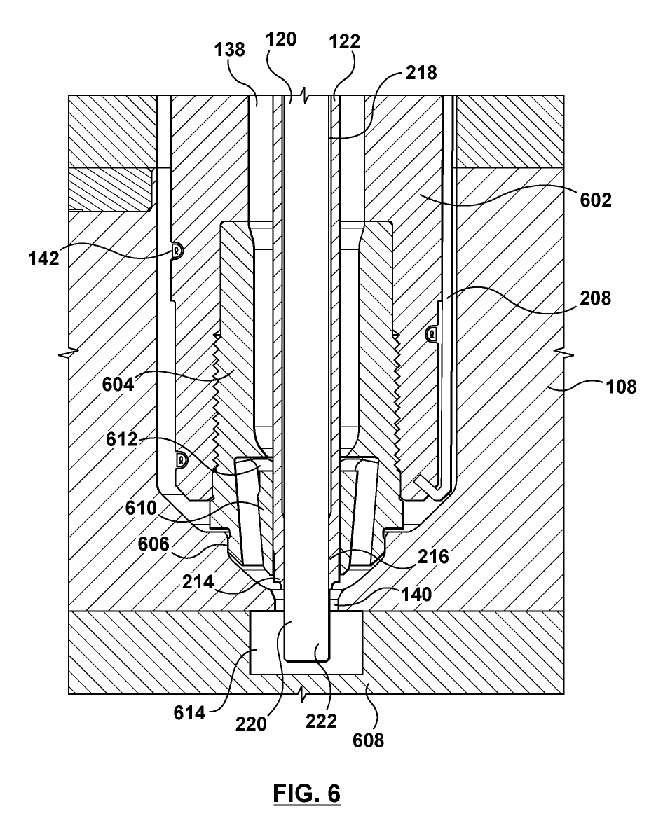

FIG. 6 shows another embodiment of an injection molding apparatus according to the present invention. Components near the downstream end of a nozzle 602 are illustrated, and components not illustrated are similar to those shown for the other embodiments. Only differing features and aspects of the present embodiment are described in detail. For description of the like parts, the other embodiments can be referenced. The features and aspects described for the other embodiments can be used accordingly with the present embodiment.

Threaded into a downstream bore of the nozzle 602 is a one-piece nozzle tip 604. The nozzle tip 604 has a seal portion 606 that seals with a cavity plate 108, an alignment portion 610 that aligns the sleeve 122 with the mold gate 140, and lateral channels 612 to allow flow of molding material around the alignment portion 610. A mold cavity 614 is defined between the cavity plates 108, 608. In this embodiment, the tip 220 of the pin 120 does not contact the cavity plate 608, and thus the product feature defined by the pin 120 is a recess rather than a through-hole. Operation is similar to the other embodiments.

Regarding materials and manufacture of the present invention, any materials and manufacturing methods suitable for making injection molding apparatuses may be used.

Although preferred embodiments of the present invention have been described, those of skill in the art will appreciate that variations and modifications may be made without departing from the spirit and scope thereof as defined by the appended claims. All patents and publications discussed herein are incorporated in their entirety by reference thereto.

What is claimed is:

1. An injection molding apparatus, comprising:
a manifold defining a manifold channel for distributing molding material;
at least one nozzle connected to the manifold, the nozzle defining a nozzle channel in communication with the manifold channel for conveying molding material to a mold gate of a mold cavity, the nozzle having a nozzle tip including an alignment portion;
a pin extending through the nozzle and into the mold cavity to define a product feature of the mold cavity;
a sleeve extending through the nozzle and circumferentially surrounding a portion of the pin, the sleeve being movable for controlling flow of molding material through the mold gate, the sleeve being aligned with the mold gate by the alignment portion when opening the mold gate; and
an actuator connected to the sleeve for moving the sleeve between an open position separated from the mold gate and a closed position within the mold gate.

2. The injection molding apparatus of claim 1, wherein the sleeve is cylindrical and the alignment portion is a hollow tube including an inner surface that slidably mates with an outer surface of the sleeve.

3. The injection molding apparatus of claim 2, wherein the sleeve slidably mates with the alignment portion over an entire range of motion of the sleeve.

4. The injection molding apparatus of claim 1, wherein the nozzle tip includes a lateral channel upstream of the alignment portion for flow of molding material.

5. The injection molding apparatus of claim 1, wherein a tip of the sleeve extends into the mold cavity in the closed position to define another product feature of the mold cavity.

6. The injection molding apparatus of claim 1, wherein the pin includes an outer surface that contacts an inner surface of the sleeve to align the pin to the mold gate.

7. The injection molding apparatus of claim 6, wherein the alignment portion circumferentially surrounds the portion of the sleeve that contacts the pin.

8. The injection molding apparatus of claim 6, wherein a tip of the pin slidably mates with a tip of the sleeve.

9. The injection molding apparatus of claim 1, further comprising a pin holder holding a head of the pin.

10. The injection molding apparatus of claim 9, wherein the pin holder comprises a spring for seating the pin in the mold cavity.

11. The injection molding apparatus of claim 1, wherein a tip of the pin contacts a mold core or cavity plate and the product feature is a through-hole.

12. The injection molding apparatus of claim 1, wherein the pin is stationary with respect to the nozzle when a mold defining the mold cavity is closed.

13. An injection molding apparatus, comprising:
a manifold and nozzle assembly defining one or more heated channels for conveying molding material from an injection molding machine to one or more mold cavities;
a pin extending through a nozzle channel of the one or more channels and into a mold cavity of the one or more mold cavities to define a product feature of the mold cavity;
a sleeve circumferentially surrounding a portion of the pin, the sleeve movable for controlling flow of molding material through a mold gate of the mold cavity;
an actuator connected to the sleeve for moving the sleeve; and
an alignment portion adjacent the mold cavity, the alignment portion continuously aligning the sleeve to the mold gate.

14. The injection molding apparatus of claim 13, wherein the sleeve aligns the pin to the mold gate by a tip of the pin slidably mating with a tip of the sleeve.

15. The injection molding apparatus of claim 13, wherein the pin extends through the actuator and the pin is connected to a pin holder having a spring for seating the pin in the mold cavity.

16. The injection molding apparatus of claim 13, wherein the alignment portion circumferentially surrounds a portion of the sleeve that contacts and aligns the pin to the mold gate.

17. The injection molding apparatus of claim 13, wherein the pin is stationary with respect to the nozzle when a mold defining the mold cavity is closed.

18. A method of operating an injection molding apparatus, the injection molding apparatus including a nozzle, a pin extending into a mold cavity to define a product feature and a sleeve circumferentially surrounding a portion of the pin, the method comprising the steps of:
sliding the sleeve between an open position wherein the sleeve is separate from a mold gate of the mold cavity and a closed position wherein the sleeve engages the mold gate;
while sliding the sleeve, continuously aligning to the mold gate a portion of the sleeve adjacent the mold gate with an alignment portion of the nozzle; and
when the sleeve is in the opening position, injecting heated molding material around the sleeve, through the mold gate, and into the mold cavity.

19. The method of claim 18, further comprising the step of aligning the pin in the mold cavity by slidably contacting a portion of the pin with the sleeve.

20. The method of claim 18, further comprising the step of contacting a tip of the pin with a mold core or cavity plate to define the product feature as a through-hole.

21. The method of claim 18, wherein the pin is stationary with respect to the nozzle when a mold defining the mold cavity is closed.

22. A method of operating an injection molding apparatus to make a closure, comprising the steps of:
when closing a mold to define a mold cavity, defining a through-hole of the closure by aligning a pin inside the mold cavity with a sleeve that circumferentially surrounds a portion of the pin by contacting a portion of the sleeve with a portion of the pin adjacent the mold cavity;
after the mold is closed, moving the sleeve to open a mold gate of the mold cavity while aligning to the mold gate a portion of the sleeve adjacent the mold gate;
injecting molding material around the sleeve, through the mold gate, around the tip of the pin inside the mold cavity, and into the mold cavity;
after the mold cavity is filled with molding material, moving the sleeve to close the mold gate; and
ejecting the injection molded closure.
